(19) United States
(12) Patent Application Publication
(10) Pub. No.: US 2005/0212954 A1
(43) Pub. Date: Sep. 29, 2005

(54) Remote-shooting apparatus

(75) Inventors: Takehico Senba, Asaka (JP); Mikio Watanabe, Asaka (JP); Kazuhiro Tokuda, Asaka (JP); Kazukiyo Tamada, Asaka (JP); Kentaro Tokiwa, Asaka (JP); Kazuki Iwabe, Asaka (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/088,186

(22) Filed: Mar. 24, 2005

(30) Foreign Application Priority Data
Mar. 26, 2004 (JP) 2004-091293

(51) Int. Cl. H04N 5/232

(52) U.S. Cl. 348/360

(57) ABSTRACT

The present invention provides a technique which enables remote operation and a remote-shooting system while watching a monitor display using a compact camera and simple accessories. A transmission unit has a mount connected to a lens unit, a transmission section and a power supply section. A reception unit has a mount connected to a camera body and a reception section. The reception unit is connected to the camera body to make the camera body act as a remote controller for image monitoring, selection of a shooting mode, and release operation and the like, thereby providing a remote-shooting function through communication between the transmission unit and the reception unit.

### BACKGROUND OF THE INVENTION

1. Field of the Invention

The present invention relates to a remote-shooting apparatus, in which a lens unit and a main body of a camera are isolated and are provided with interoperative remote-shooting function.

2. Description of the Related Art

Conventionally there is known a technique that image information of a camera with transmission capability can be remote-controlled while watching the image displayed on a monitor at a location some distance away from the camera.

For example, a video camera can be controlled on hand while watching an image being shot by the video camera in real time. Particularly, such a video camera has a video camera section with transmission capability and a monitor section. The monitor section receives an image from the video camera section and transmits a signal to remote-control the operation status of the video camera. The video camera is configured in such a way that both sections are provided separately, and that a recording means and an optical system installed in the video camera can be remote-controlled while the image is being monitored (for example, see Japanese Patent Application Publication No. 8-32844).

However, the above technique is applied to a video camera apparatus used for shooting moving images, and needs a separated command input device. Therefore the apparatus is heavy and complicated.

Alternatively, there is a camera position transformation device which adjusts a viewing angle such as pan and tilt using remote-controlled operation (for example, see Japanese Patent Application Publication No. 6-18964).

The device uses a common motor and transmission mechanism for adjusting panning (right and left moving angle) and tilting (elevation angle) of a camera. The device is a pan head (a tripod head) in which a planetary gear is used as transmission mechanism. Destination of power transmission automatically changes depending on the rotation of a motor (counterclockwise or clockwise), thereby controlling the position of the camera.

Further, there is a technique by which a user can remote-control operation of a pan-tilter, on which a video camera is mounted, as well as operation of the camera while watching an image displayed on a monitor on hand (for example, see Japanese Patent Application Publication No. 6-121215).

According to the above technique, a display section is provided on a remote control section of the pan-tilter on which a video camera with panning, tilting and zoom capabilities is mounted. The display section shows the image equivalent to the one viewed through a viewfinder of the video camera. The technique is to be applied to the video camera for a burglar alarm system.

Further, there is an image data wireless transmission apparatus which enables remote control while watching a display monitor (for example, see Japanese Patent Application Publication No. 11-239292).

The apparatus has an image-taking device such as a camera mounted on a pan head, an image transfer section, and a display monitor. The image transfer section further has an operation section to control operation of a TV camera such as panning, tilting, zooming and focusing, and a shift section between a remote mode and local mode, so that the angle and focusing of the camera can be easily set when camera is mounted.

### SUMMARY OF THE INVENTION

The present invention has been made in view of the above circumstances, and provides a technique which enables remote operation and a remote-shooting system while watching a monitor display using a compact camera and simple accessories without a heavy remote controller of a video camera or structurally complicated pan-tilt mechanism.

The present invention provides a remote-shooting apparatus with the following technique. In a remote-shooting apparatus having a lens unit and a camera body, the lens unit incorporating an image pickup device and an image pickup processing circuit which communicates with and transfers an image to the camera body via a connector in a mount, the camera body incorporating a monitor section and an operation section, the apparatus having:
a transmission unit, provided with a mount connected to the lens unit, a transmission section and a power supply section;
a reception unit, provided with a mount connected to the camera body and a reception section; and
a remote-shooting function through communication between the transmission unit and the reception unit.

According to the present invention, a camera body is a remote controller with a monitor. A lens unit and a camera body are respectively equipped with a transmission unit and a reception unit, enabling remote-shooting.

In the remote-shooting apparatus, a reception unit is connected to the camera body to make the camera body act as a remote controller which monitors an image, selects a shooting mode and controls various operations such as release. Therefore the camera body itself can act as a controller for remote-shooting, eliminating the need for providing an exclusive controller.

In addition, in the remote-shooting apparatus, the lens unit, without a power-zoom function, has a device to link a zoom-driving gear of the transmission unit to a gear provided on outer/inner circumference of a ring for zoom operation in order to realize remote-controlled zoom operation. A zoom actuator is provided in the transmission section, thereby eliminating the need for a zoom actuator in a lens.

In the remote-shooting apparatus according to present invention, the reception unit is of nearly identical shape with the lens unit to have all or part of a focus ring, a zoom ring, and an aperture ring. Therefore, a user can operate the reception unit easily just like operating a lens unit and manual operation is to be automatically linked to remote operation, making shift of operation prompt and easy. In this way, a reception unit of similar shape with a lens unit offers ease of use and user-friendliness.

According to the present invention, it is possible to provide a technique which enables remote operation and a remote-shooting system while watching a monitor display using a compact camera and simple accessories without a heavy remote controller of a video camera or structurally complicated pan-tilt mechanism.

### BRIEF DESCRIPTION OF THE DRAWINGS

FIG. 1(a) is a perspective view showing a lens unit side according to an embodiment of the present invention.

FIG. 1(b) is a perspective view showing a camera body side according to an embodiment of the present invention.

FIG. 2 is a perspective view of a remote-shooting controller on the camera body side.

FIG. 3(a) is a side view showing the outline of a lens unit.

FIG. 3(b) is an explanatory view showing accessories of a transmission unit.

FIG. 4(a) is a perspective view of a lens unit.

FIG. 4(b) is a perspective view of a transmission unit.

FIG. 5(a) is a detail view showing the vicinity of a joint receiver of a lens unit.

FIG. 5(b) is a detail view showing the vicinity of a joint of a transmission unit.

FIG. 6 is a side view showing an outline of a reception unit according to an embodiment of the present invention.

FIG. 7 is a perspective view of a camera to which the present invention is applied.

### DETAILED DESCRIPTION OF THE INVENTION

Embodiments of the present invention will be described below with reference to the attached drawings.

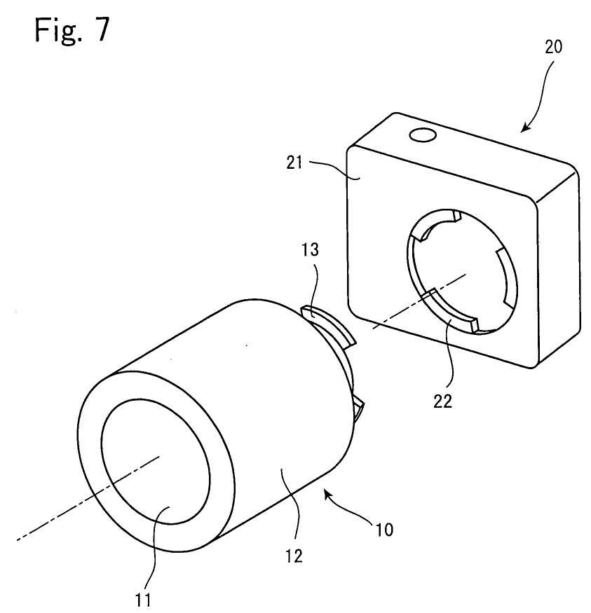

As shown in FIG. 7, the present invention is applied to a camera system in which a lens unit 10 and a camera body 20 are removably connected, and is used in such a way that a lens unit 10 and a camera body 20 are separated mounting a transmission unit and reception unit respectively according to the present invention. FIG. 7 shows a lens 11, a barrel 12, a lens-side mount 13, a camera housing 21, and a camera-side mount 22. A lens unit 10 and a camera body 22 are connected by fitting a lens-side mount 13 with a camera-side mount 22.

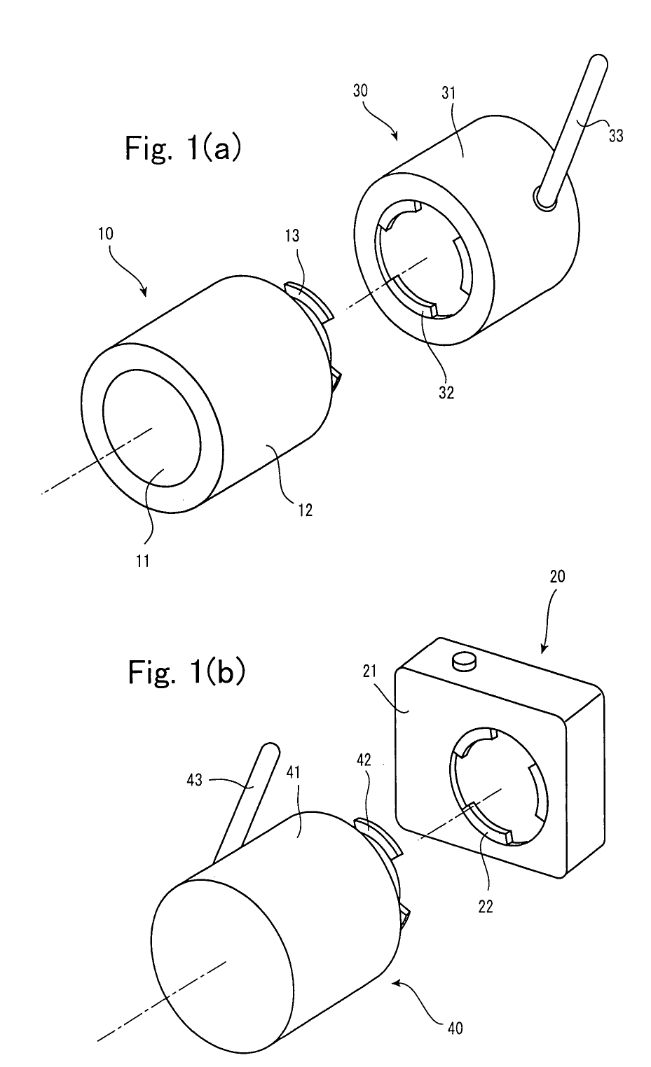

FIG. 1(a) and FIG. 1(b) show a perspective view according to an embodiment of the present invention. As mentioned earlier, the present invention is applied to an apparatus having a lens unit 10 incorporating an image pickup device and an image pickup processing circuit which communicates and transfers an image via a connector in a mount, and a camera body 20 incorporating a monitor section and an operation section. The present invention is provided with a transmission unit 30 shown in FIG. 1. The transmission unit 30 has a mount 32 to be fitted with a lens-side mount 13 of the lens unit 10. A transmission unit 30 incorporating an image pickup device and an image pickup processing circuit in its body is connected with a lens unit 10 via a connector in a mount 32, thereby communicating with and transferring an image to a camera body 20.

FIG. 1(b) shows a reception unit 40 to be connected to a camera body 20. A reception unit 40 has a mount 42 to be fitted with a camera mount 22 of a camera body 20, a reception section in the body 41 of a reception unit 40 and an antenna 43. The transmission unit 30 and the reception unit 40 communicate via antennas 33 and 43 and have a remote-shooting function.

According to the present invention, an image pickup device, which is obtained by connecting a transmission unit 30 to a lens unit 10 shown in FIG. 1(a), is controlled by a remote controller, which is obtained by connecting a reception unit 40 to a camera body 20 shown in FIG. 1(b), in order to perform remote-shooting.

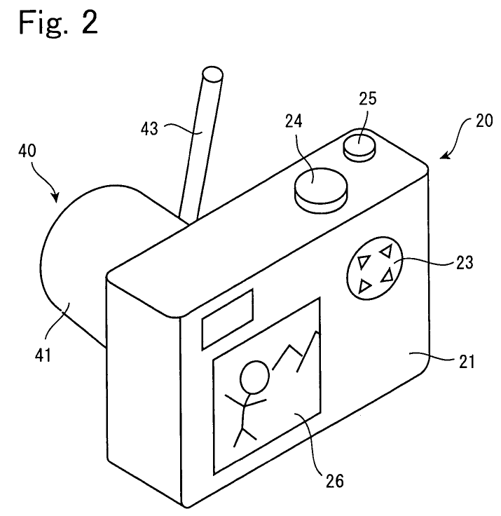

FIG. 2 shows a remote controller obtained by connecting a reception unit 40 to a camera body 20 which monitors an image, selects a shooting mode and performs operations such as release on the side of the camera body 20.

Remote-shooting is performed using the remote controller shown in FIG. 2 as follows. A user adjusts a zoom key 23 and a mode dial 24 and presses a release button while watching a monitor 26. Then a signal will be sent from a reception unit 40 to a transmission unit 30.

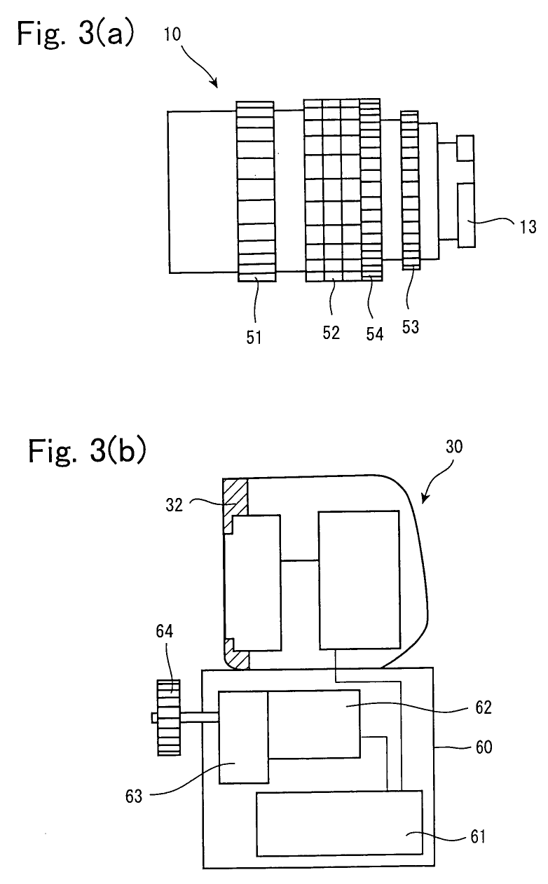

FIG. 3(a) and FIG. 3(b) illustrate mechanism of the function of a lens unit 10. FIG. 3(a) shows a focus ring 51, a zoom ring 52 and an aperture ring 53, and a gear 54 for operating the rings, which are provided on the outer circumference of a lens unit 10. As shown in FIG. 3(b), a driving device is annexed to a transmission unit 60. The driving device has a power supply section 61, a motor 62, a speed reducer 63 and a pinion 64. When the mount 32 of transmission unit 30 in FIG. 3(b) is fitted with the lens mount 13 of a lens unit 10 in FIG. 3(a), a pinion 64 is engaged with a gear 54.

A signal sent from a camera body 20 to a transmission unit 30 causes a driving device 60 annexed to a transmission unit 30 to move, leading to transmission of rotation force from a pinion 64 to a gear 54. A gear 54 selects from a focus ring 51, a zoom ring 52 and an aperture ring 54 to cause it to move for the purpose of desired adjustment. Although FIG. 3(a) and FIG. 3(b) show external engagement of a pinion 64 and a gear 54, internal engagement may also be applied.

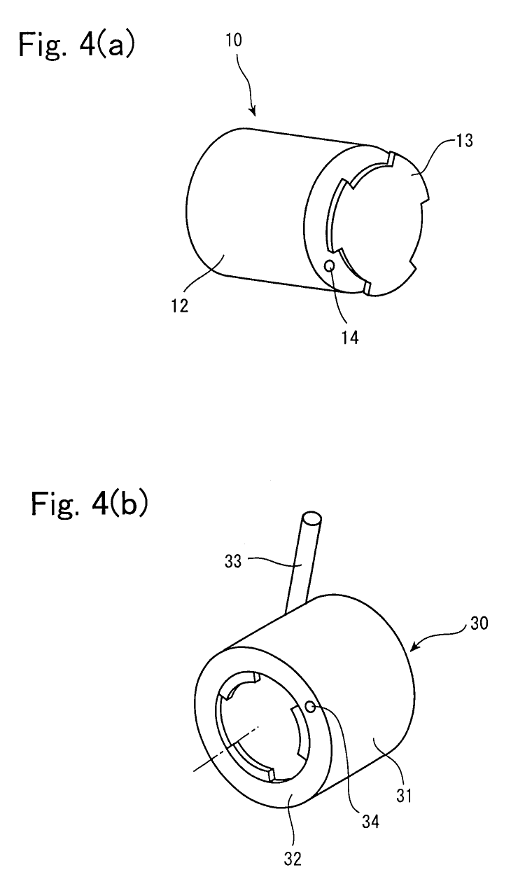

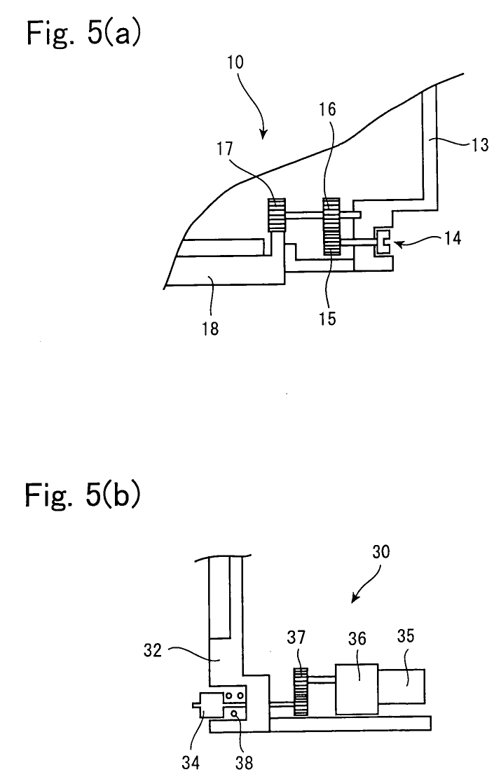

FIGS. 4 and 5 show another embodiment according to the present invention.

FIG. 4(a) shows a lens unit 10 with a joint receiver section 14 provided on the surface of a lens mount 13, while FIG. 4(b) shows a transmission unit 30 with a joint 34 on the surface of a mount 32. When a lens unit 10 in FIG. 4(a) is connected to a transmission unit 30 in FIG. 4(b) by fitting a mount 32 to a mount 13, a joint 34 is engaged with a joint receiver section 14.

FIG. 5(a) and FIG. 5(b) are detail views showing the vicinity of a joint receiver section 14 of a lens unit and the vicinity of a joint 34 of a transmission unit 30. As illustrated in FIG. 5(a), a joint receiver section 14 causes a zoom ring 18 to rotate via gears 15,16 and 17, while, as shown in FIG. 5(b), a joint 34 of a transmission unit 30 is caused to be moved by a motor 35, a speed reducer 36, and a gear device 37. A joint 34 is pressed toward the direction of its projection by an energizing means such as a spring.

When a lens unit 10 and a transmission unit are connected by fitting a mount 32 in FIG. 5(b) to a lens mount 13 in FIG. 5(a), a joint 34 is engaged with a joint receiver section 14. Consequently, a motor 35 can cause a zoom ring 18 of a lens unit 10 to rotate.

Similarly a focus ring 51 and an aperture rig 53 may be selected to be driven.

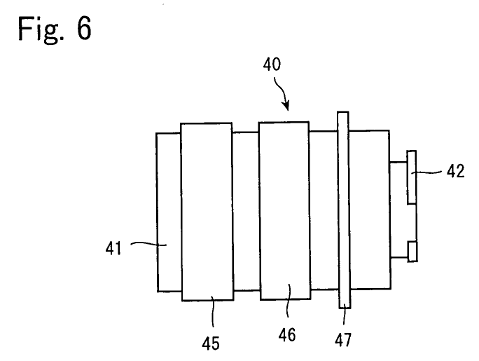

FIG. 6 shows a reception unit 40 according to another embodiment, which is of nearly identical shape with the outline of a lens unit and has a focus ring 45, a zoom ring 46, and an aperture ring 47 of nearly identical shape with the rings annexed to a lens unit. Any of the rings 45,46 and 47 can be omitted.

The focus ring 51, the zoom ring 52 and the aperture ring 53 of a lens unit 10 at a location some distance away from a user is remote-controlled by manually operating the focus ring 45, the zoom ring 46 and the aperture ring 47 of a reception unit 40 provided on its outer circumference, which is easy to operate just like operating an outer circumference of a lens unit. In this way, a user can operate remote-controlled shooting easily as if he/she were shooting by holding an ordinary camera.

1. In a remote-shooting apparatus comprising a lens unit and a camera body, the lens unit incorporating an image pickup device and an image pickup processing circuit which communicates with and transfers an image to the camera body via a connector in a mount, the camera body incorporating a monitor section and an operation section, the apparatus comprising:
a transmission unit, provided with a mount connected to the lens unit, a transmission section and a power supply section;
a reception unit, provided with a mount connected to the camera body and a reception section; and
a remote-shooting function through communication between the transmission unit and the reception unit.

2. The remote-shooting apparatus according to claim 1, wherein the reception unit is connected to the camera body to make the camera body act as a remote controller which monitors an image, selects a shooting mode and controls various operations such as release.

3. The remote-shooting apparatus according to claim 1, wherein the lens unit, without a power-zoom function, has a device to link a zoom-driving gear of the transmission unit to a gear provided on outer/inner circumference of a ring for zoom operation in order to realize remote-controlled zoom operation.

4. The remote-shooting apparatus according to claim 2, wherein the lens unit, without a power-zoom function, has a device to link a zoom-driving gear of the transmission unit to a gear provided on outer/inner circumference of a ring for zoom operation in order to realize remote-controlled zoom operation.

5. The remote-shooting apparatus according to claim 1, wherein the reception unit is of nearly identical shape with the lens unit to have all or part of a focus ring, a zoom ring and an aperture ring.

6. The remote-shooting apparatus according to claim 2, wherein the reception unit is of nearly identical shape with the lens unit to have all or part of a focus ring, a zoom ring and an aperture ring.

7. The remote-shooting apparatus according to claim 3, wherein the reception unit is of nearly identical shape with the lens unit to have all or part of a focus ring, a zoom ring and an aperture ring.
